(19) United States
(12) Patent Application Publication
(10) Pub. No.: US 2006/0056733 A1
(43) Pub. Date: Mar. 16, 2006

(54) Image comparing method, computer program product, and image comparing apparatus

(75) Inventors: Jun Minakuti, Sakai-shi (JP); Atsushi Ueda, Ritto-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/185,252

(22) Filed: Jul. 20, 2005

(30) Foreign Application Priority Data
Sep. 14, 2004 (JP) JP2004-266964

(51) Int. Cl. G06K 9/36; G06K 9/00; G06K 9/54; H04N 5/76

(52) U.S. Cl. 382/286; 382/112; 382/305; 348/231.2

(57) ABSTRACT

In an image processing apparatus, on a display screen, a plurality of images can be displayed in parallel in an image display area, and, for example, a focus evaluation value for comparing focus states of the images can be displayed on a comparison result display area. As the focus evaluation value, high frequency component images are generated from a plurality of images by using a high pass filter, and a standard deviation obtained from a histogram of each of the high frequency component images is used. Consequently, a quantitative index can be provided to the user in the case of comparing a plurality of images.

This application is based on application No. 2004-266964 filed in Japan, the contents of which are hereby incorporated by reference.

### BACKGROUND OF THE INVENTION

1. Field of the Invention

The present invention relates to an image comparing technique for comparing a plurality of images.

2. Description of the Background Art

In a digital camera, the user does not have to mind the number of remaining frames unlike a silver-halide film camera, so that the user tends to take a large number of pictures for a single scene while variously changing the tone of color by exposure or filtering, the angle of view, face expression and pose of a subject, lighting, and the like.

In the case where the user performs photographing a number of times for a specific scene, a work of selecting a preferable one from a series of images has to be done.

A technique for efficiently doing the image selecting work is disclosed in, for example, Japanese Patent Application Laid-Open No. 11-45334 (1999). In the technique, a plurality of images are displayed on a single screen and can be interacted with each other for movement, enlargement display, reduction display, or the like.

According to Japanese Patent Application Laid-Open No. 11-45334 (1999), a plurality of images displayed on a screen can be subjectively compared with each other by human eyes. However, it is difficult to make quantitative and objective comparison on focus, exposure amount, white balance and the like.

### SUMMARY OF THE INVENTION

The present invention is directed to an image comparing method.

According to the present invention, the method comprises the steps of: (a) obtaining a plurality of images to be compared; (b) generating numerical information of a specific comparison item on the basis of each of the plurality of images; and (c) displaying the plurality of images in parallel on a display screen and performing information display based on the numerical information. Therefore, the present invention can provide a quantitative index in the case of comparing a plurality of images.

In a preferred embodiment of the present invention, according to the method, the information display includes display based on a relative value with respect to a reference value. Consequently, an index which is easily recognized can be provided.

The present invention is also directed to a computer program product and an image comparing apparatus.

Therefore, an object of the present invention is to achieve an image comparing technique capable of providing a quantitative index at the time of comparing a plurality of images.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing the configuration of a main portion of an image processing system according to a preferred embodiment of the present invention;

FIG. 2 is a diagram showing functional blocks of the image processing system;

FIG. 3 is a diagram illustrating the structure of an image comparing program;

FIG. 4 is a diagram showing a display screen in the case where the image comparing program is executed;

FIG. 5 is a diagram showing a pull-down menu;

FIG. 6 is a flowchart showing operations of an image processing apparatus;

FIG. 7 is a flowchart showing operations of generating comparison images in focus comparison;

FIG. 8 is a diagram illustrating an image process with a high pass filter;

FIG. 9 is a flowchart showing operations of calculating a characteristic amount in focus comparison;

FIGS. 10A and 10B are diagrams illustrating the relation between a focus state and a differential image;

FIGS. 11A and 11B are diagrams illustrating a standard deviation of a histogram of a differential image which changes according to a focus state;

FIGS. 12 and 13 are diagrams showing an example of display on focus comparison;

FIG. 14 is a flowchart showing operations of calculating a characteristic amount in exposure amount comparison;

FIGS. 15 and 16 are diagrams showing an example of display on exposure amount comparison;

FIG. 17 is a flowchart showing operations of calculating a characteristic amount in white balance comparison;

FIGS. 18 to 20 are diagrams showing an example of display on white balance comparison;

FIG. 21 is a flowchart showing operations of calculating a characteristic amount in blur amount comparison;

FIGS. 22A and 22B are diagrams illustrating the relation between a power spectrum and a blur amount; and

FIGS. 23 and 24 are diagrams showing an example of display on the blur amount comparison.

### DESCRIPTION OF THE PREFERRED EMBODIMENTS

Configuration of Main Portion of Image Processing System

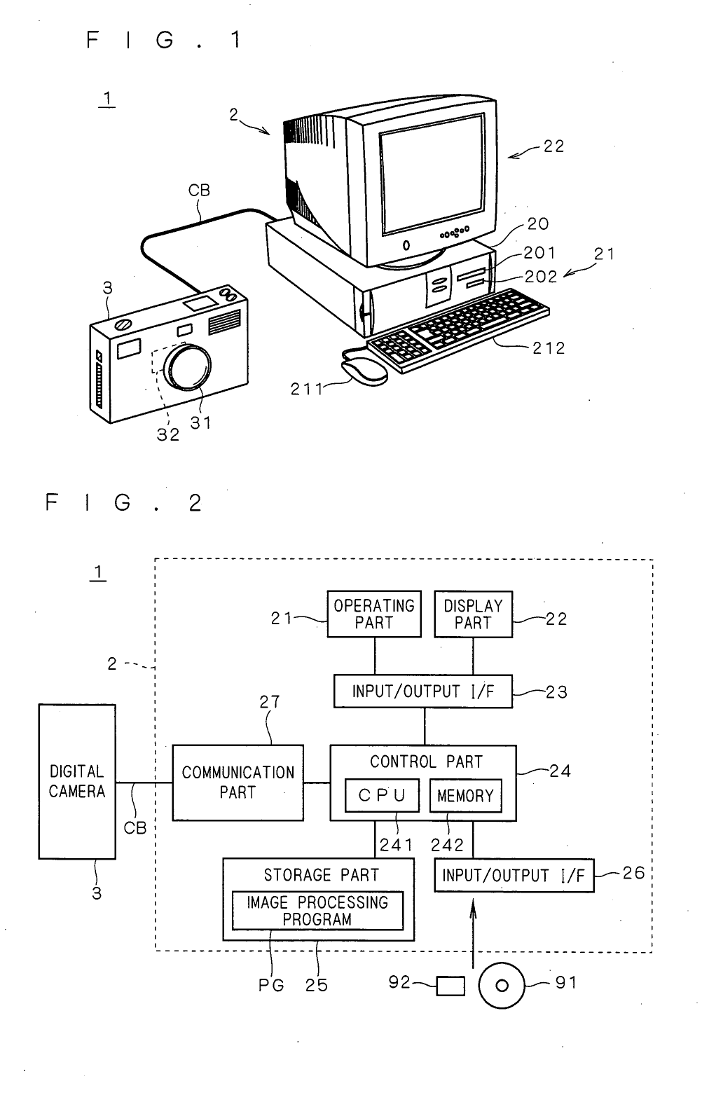

FIG. 1 is a schematic view showing the configuration of a main portion of an image processing system 1 according to a preferred embodiment of the present invention.

The image processing system 1 has an image processing apparatus 2 constructed as, for example, a personal computer, and a digital camera 3 connected to the image processing apparatus 2 via a cable CB so as to be able to perform communications.

The image processing apparatus 2 has a processing part 20 having a box shape, an operating part 21, and a display part 22, and functions as an image comparing apparatus.

In the front face of the processing part 20, a drive 201 into which an optical disc 91 is inserted and a drive 202 into which a memory card 92 is inserted are provided.

The operating part 21 has a mouse 211 and a keyboard 212, and accepts an operation input to the image processing apparatus 2 from the user.

The display part 22 takes the form of, for example, a CRT monitor.

The digital camera 3 photoelectrically converts an optical image of a subject formed by a taking lens 31 by an image capturing device 32 taking the form of, for example, a CCD, thereby enabling image data to be generated. The image data generated by the digital camera 3 can be supplied to the image processing apparatus 2 via the cable CB.

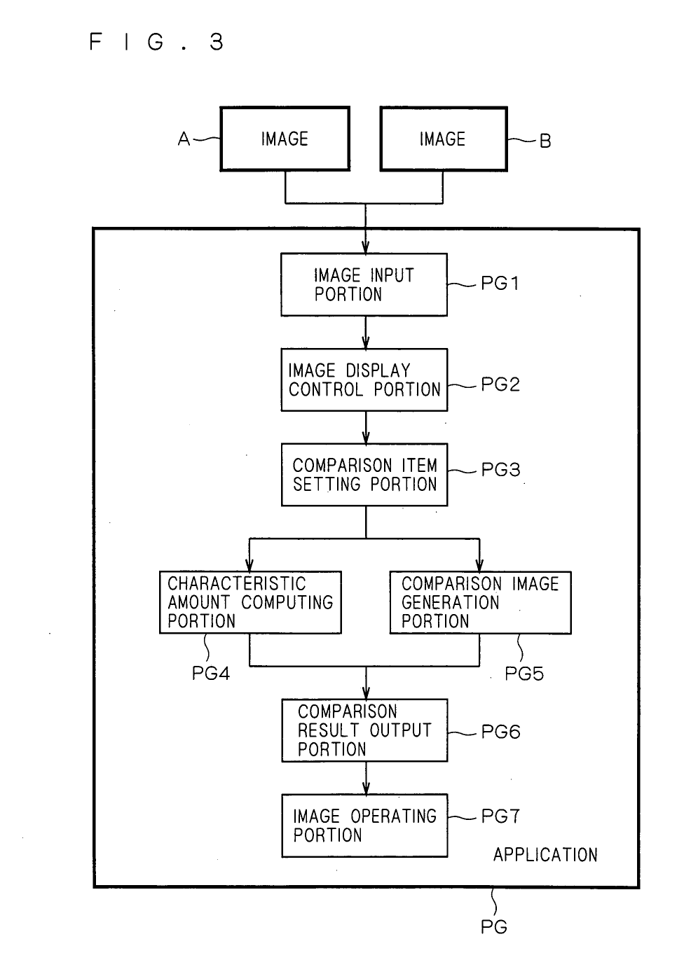

FIG. 2 is a diagram showing functional blocks of the image processing system 1.

The image processing apparatus 2 has an input/output I/F 23 connected to the operating part 21 and the display part 22, and a control part 24 connected to the input/output I/F 23 so as to be able to transmit data. The image processing apparatus 2 also has a storage part 25 connected to the control part 24 so as to be able to transmit data, an input/output I/F 26, and a communication part 27.

The input/output I/F 23 is an interface for controlling transmission/reception of data among the operating part 21, display part 22, and control part 24.

The storage part 25 is constructed as, for example, a hard disk and stores an image comparing program PG which will be described later or the like.

The input/output I/F 26 is an interface for inputting/outputting data from/to the optical disc 91 and memory card 92 as recording media via the drives 201 and 202. Via the input/output I/F 26, for example, the image processing apparatus 2 can acquire a plurality of pieces of image data recorded on the memory card 92.

The communication part 27 is an interface for performing communications with the digital camera 3 via the cable CB. By the communication part 27, the plurality of pieces of image data acquired by the digital camera 3 can be input to the image processing apparatus 2.

The control part 24 has a CPU 214 functioning as a computer and a memory 242, and is a part for controlling the operations of the image processing apparatus 2 in a centralized manner. By executing the image comparing program PG in the storage part 25 by the control part 24, comparison of focusing or the like which will be described later can be displayed.

Program data such as the image comparing program PG recorded on the optical disc 91 can be installed to the memory 242 in the control part 24 via the input/output I/F 26. Consequently, the stored program can be reflected in the operations of the image processing apparatus 2.

Image Comparing Program PG

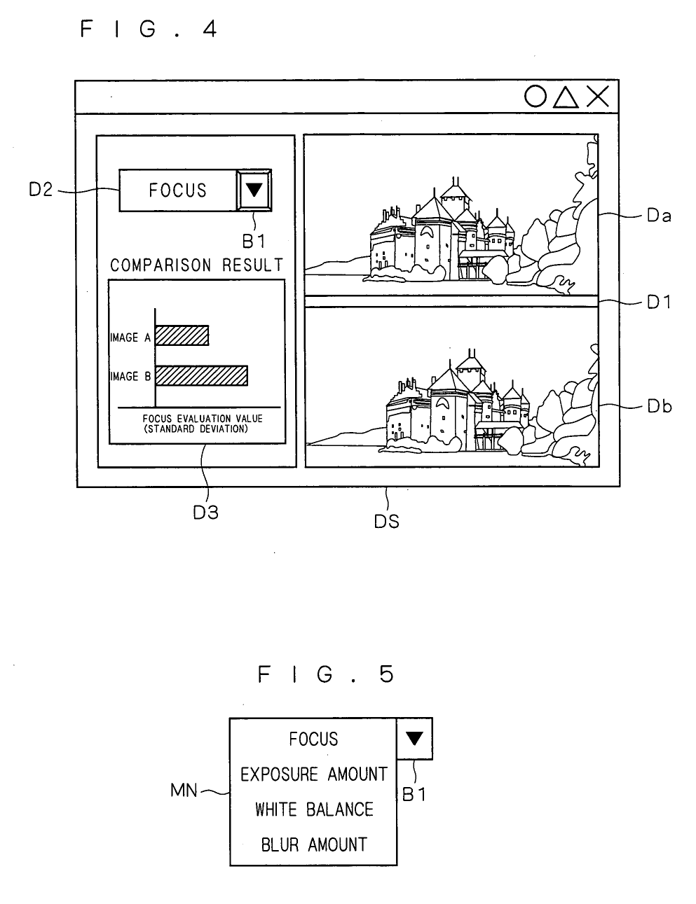

FIG. 3 is a diagram illustrating the structure of the image comparing program PG. FIG. 4 is a diagram showing a display screen DS in the case where the image comparing program PG is executed.

The image comparing program PG has an image input portion PG1, an image display control portion PG2, a comparison item setting portion PG3, a characteristic amount computing portion PG4, a comparison image generating portion PG5, a comparison result output portion PG6, and an image operating portion PG7 functioning as subroutines. Each of the portions functions when executed by the control part 24.

When a plurality of images, for example, images A and B captured by the digital camera 3 and received by the communication part 27 are input to the image input portion PG1, the images A and B are displayed on first and second image areas Da and Db of an image display area D1 shown in FIG. 4 by the image display control portion PG2.

The comparison item setting portion PG3 sets a comparison item which is designated by the user for comparing the images A and B.

A comparison item is designated by clicking a selection button B1 shown in FIG. 4 with the mouse 211 and selecting one of a plurality of comparison items, concretely, “focus”, “exposure amount”, “white balance”, and “blur amount” in the pull-down menu MN displayed on the screen as shown in FIG. 5. The selected comparison item is displayed on the comparison item display area D2 shown in FIG. 4.

The characteristic amount computing portion PG4 calculates a characteristic amount necessary for comparing the images A and B on the basis of the comparison item which is set by the comparison item setting portion PG3.

The comparison image generating portion PG5 generates a comparison image by performing an image process (for example, filter process) on the input images A and B.

In the characteristic amount computing portion PG4 and comparison image generating portion PG5, parallel processes on the input images A and B are performed.

The comparison result output portion PG6 displays the result of processes performed by the characteristic amount computing portion PG4 and the comparison image generating portion PG5 on a comparison result display area D3 and the image display area D1 shown in FIG. 4, respectively.

The image operating portion PG7 performs a process such as shifting, enlargement display, reduction display, or the like of an image on the images A and B displayed on the image display area D1 in response to an operation input of the user with the mouse 211 or the like. In the process, the image A in the first display area Da and the image B in the second display area Db are interacted with each other.

Operations of Image Processing Apparatus 2

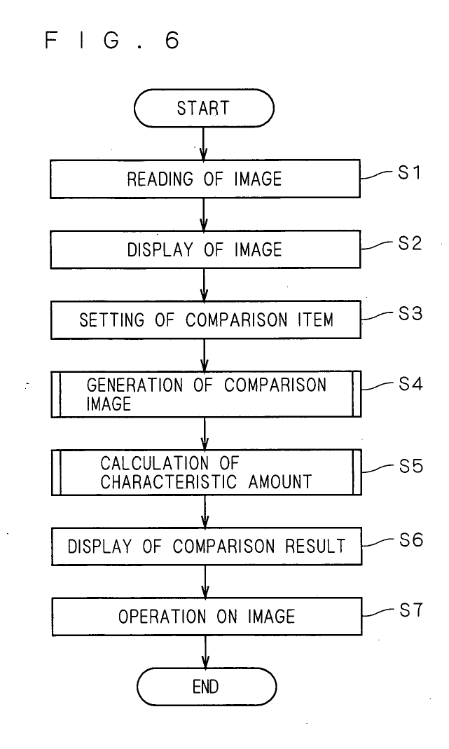

FIG. 6 is a flowchart showing the operations of the image processing apparatus 2. The operations are performed when the image comparing program PG is executed by the control part 24.

In step S1, the images A and B captured by the digital camera 3 and sent via the cable CB are read into the memory 242 in the control part 24 by the image input portion PG1. That is, a plurality of images to be compared are captured by the image processing apparatus 2.

In step S2, the images A and B read in step S1 are displayed on the image display area D1 of the display screen DS shown in FIG. 4 by the image display control portion PG2.

In step S3, a comparison item is set by the comparison item setting portion PG3. Concretely, by selecting an item from the pull-down menu MN (FIG. 5) displayed by clicking the selection button B1 shown in FIG. 4, a comparison item is set.

In step S4, a comparison image according to the comparison item which is set in step S3 is generated. Concretely, an image process is performed on the images A and B which are input by the comparison image generating portion PG5 and the resultant images are displayed on the image display area D1 (FIG. 4) so that the image comparing work can be easily visually done by the user. The operation of step S4 is performed in different circumstances according to the selected comparison item. The image process is performed on an input image only at the time of comparing focusing in the preferred embodiment (which will be described in detail later in (1) Comparison of Focusing).

In step S5, a characteristic amount according to the comparison item set in step S3 is calculated from the input image or the comparison image generated in step S4 by the characteristic amount computing portion PG4. Specifically, on the basis of each of a plurality of input images, numerical information on the comparison item which is set in step S3, concretely, any of information of a high frequency component, information of the exposure amount, information of a chromaticity value, and information of a blur amount (which will be described in detail later) is generated. The characteristic amount is calculated by performing a process which varies according to a comparison item as will be described later.

In step S6, the result of comparison calculated as the characteristic amount in step S5 is displayed on the comparison item display area D3 shown in FIG. 4 by the comparison result output portion PG6. In the case where the process in step S5 is performed, the generated comparison image is displayed on the image display area D1 (FIG. 4).

In step S7, processes such as shift of an image, enlargement display, reduction display, and the like according to an operation input of the user are interactively performed on the comparison images (or input images) displayed on the image display area D1 shown in FIG. 4 by the image operating portion PG7.

In the following, the operations in steps S4 and S5 will be described with respect to the four comparison items which can be selected by the comparison item setting portion PG3, concretely, in order of (1) focusing, (2) exposure amount, (3) white balance, and (4) blur amount.

(1) Comparison of Focusing

The operations in steps S4 and S5 performed in the case where “focusing” in the pull-down menu MN shown in FIG. 5 is set as a comparison item in step S3 in FIG. 6 will be described in detail below.

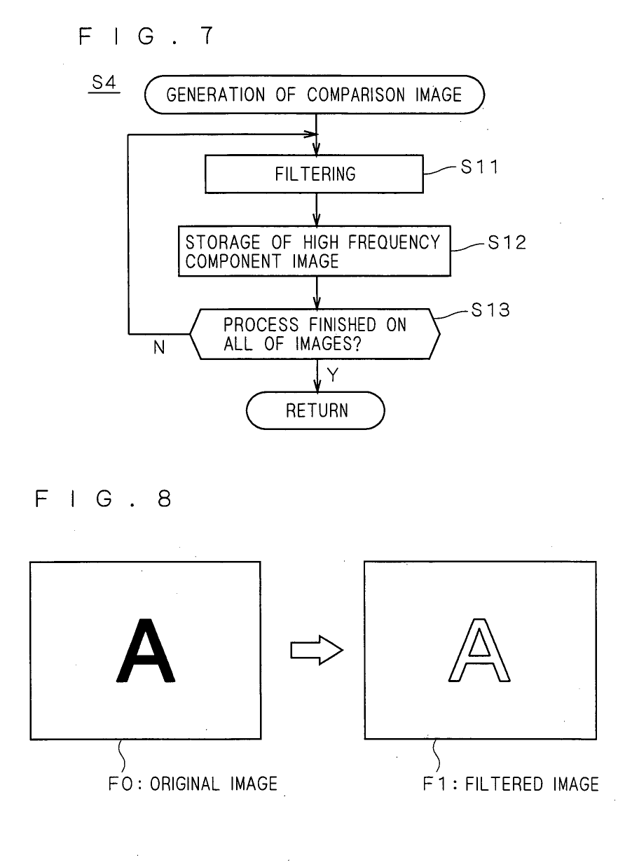

FIG. 7 is a flowchart corresponding to step S4 described above and showing the operations of generating a comparison image.

In step S11, a filtering process is performed on the images A and B read into the memory 242 in step S1 in FIG. 6.

Concretely, the image process is performed on each of the images A and B by a high-pass filter of a 3×3 matrix expressed by Equation (1) as follows.

$$[ \begin{matrix}- 1 & - 1 & - 1 \\ - 1 & + 8 & - 1 \\ - 1 & - 1 & - 1\end{matrix} ] \qquad ( 1 )$$

When the image process with the high-pass filter is performed in such a manner, for example, an original image F0 shown in FIG. 8 is converted to a filtered image F1 in which only high frequency components are displayed.

Since a focused portion in a general photographic image includes many high frequency components, a high-frequency component image in which the focused portion is emphasized by the filtering process expressed by Equation (1) can be generated.

Referring again to FIG. 7, description will be continued.

In step S12, the high frequency component image generated in step S11 is stored in the memory 242.

In step S13, whether the process has been performed on all of images input to the image input portion PG1 or not is determined. For example, if the input images are the two images A and B, the filtering process on the two images has been completed or not is determined. In the case where the process on all of the images is finished, the procedure advances to step S5. If not, the procedure returns to step S11.

In the operation of step S11, it is not essential to perform the image process with the filter expressed by Equation (1) but a process may be also performed by a differential filter for obtaining the difference of pixels in the vertical, horizontal, or oblique direction expressed by Equations (2) to (4) as follows.

$$\begin{matrix}[ \begin{matrix}0 & - 1 & 0 \\ 0 & + 1 & 0 \\ 0 & 0 & 0\end{matrix} ] & ( 2 ) \\ [ \begin{matrix}0 & 0 & 0 \\ - 1 & + 1 & 0 \\ 0 & 0 & 0\end{matrix} ] & ( 3 ) \\ [ \begin{matrix}- 1 & 0 & 0 \\ 0 & + 1 & 0 \\ 0 & 0 & 0\end{matrix} ] & ( 4 )\end{matrix}$$

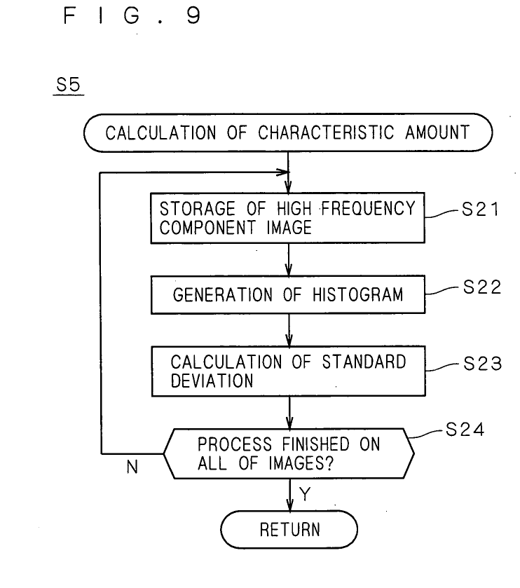

FIG. 9 is a flowchart corresponding to step S5 and showing operations of calculating a characteristic amount.

In step S21, a high frequency component image stored in step S12 in FIG. 7 is read from the memory 242.

In step S22, the high frequency component image read in step S21 is developed and a histogram is generated. For example, two histograms of an exposure amount (pixel value) corresponding to the brightness value of a subject in two high frequency component images based on the images A and B are generated.

In step S23, a standard deviation between the histograms generated in step S22 is calculated, and the calculated standard deviation is stored as a characteristic amount of focus in an input image into the memory 242. The reason why the standard deviation is calculated in step S23 will be briefly described below.

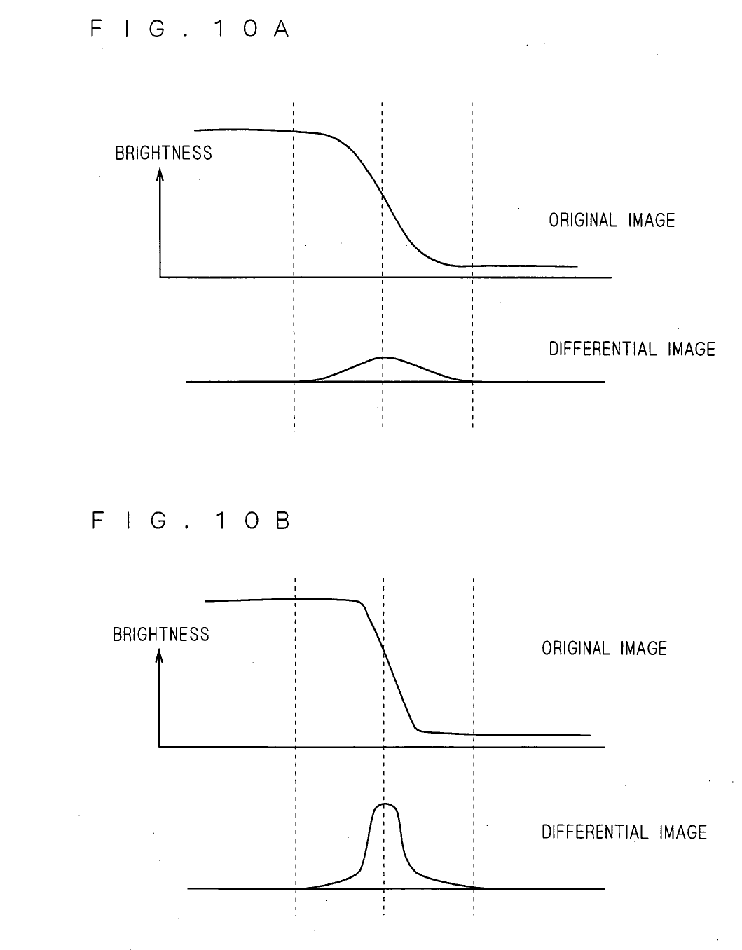

In an edge portion in an image, for example, as shown in FIG. 10A, in the case of out-of-focus, the brightness difference between neighboring pixels is small, so that the differential value is small. Therefore, dispersion in the differential image (filtered image) is small.

On the other hand, for example, as shown in FIG. 10B, in the focused case, the brightness difference between neighboring pixels is large, so that the differential value is also large. Therefore, dispersion in the differential image is large.

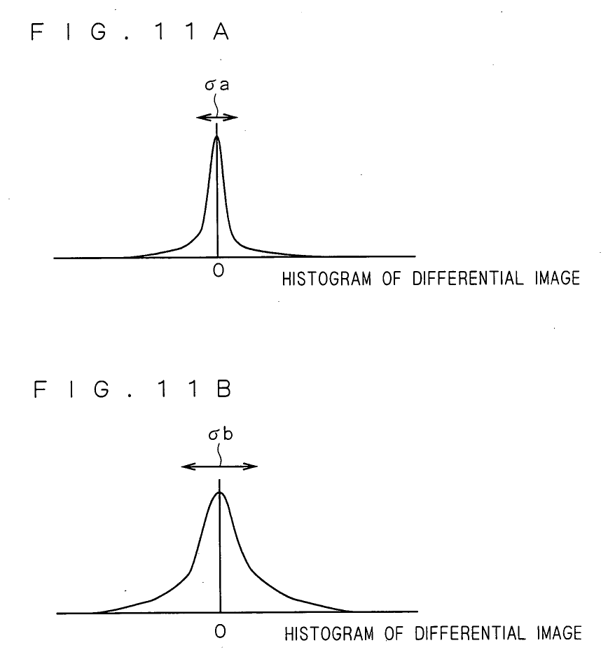

In the case of generating a histogram of a whole image or an image portion to which attention is paid in a differential image whose dispersion degree of the differential value changes according to the focus state, in an out-of-focus image, the differential values are concentrated on about 0 as shown in FIG. 11A and a standard deviation σa is small. On the other hand, in a focused image, dispersion of the differential value increases as shown in FIG. 11B, so that the standard deviation σb increases.

Therefore, by calculating the standard deviation of a histogram generated from the differential image, the focus state of the original image can be quantitatively grasped.

Referring again to FIG. 9, the description will be continued.

In step S24, whether calculation of the standard deviation has been finished on all of images input to the image input portion PG1 or not is determined. For example, when the input images are the two images A and B, computation on the two images has been completed or not is determined. In the case where the computation has been finished on all of the images, the procedure advances to step S6. When the computation has not been finished, the procedure returns to step S21.

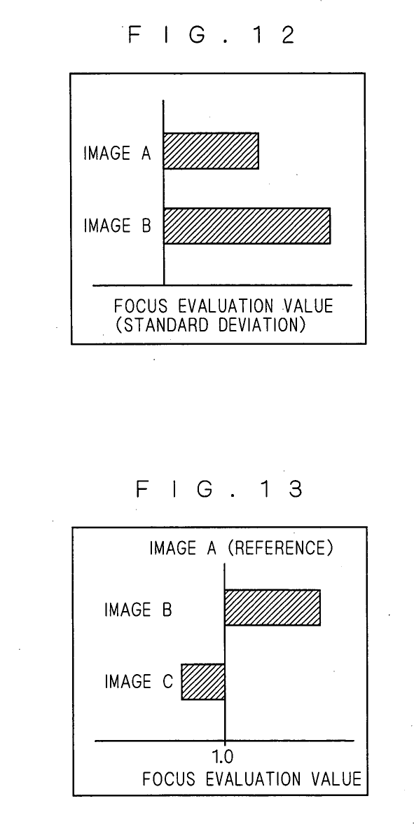

As evaluation values used for the comparison evaluation, for example, the standard deviations (focus evaluation values) obtained from a plurality of input images are expressed as a graph shown in FIG. 12 and displayed on the comparison result display area D3 (FIG. 4). Specifically, as shown in FIG. 4, a plurality of images are displayed in parallel on the display screen of the display part 22 and information is displayed on the basis of the focus evaluation value (numerical information). As a result, the user can obtain a quantitative index on the focus comparison between the images A and B.

It is not essential to display a focus evaluation value on the basis of the absolute value as shown in FIG. 12. The focus evaluation value may be displayed on the basis of a relative value with respect to a reference value obtained on the basis of one image selected as a reference image from a plurality of input images. For example, the differences among the images A, B, and C as reference images may be displayed in a graph as shown in FIG. 13.

(2) Comparison of Exposure Amounts

The operation in step S5 performed in the case where “exposure amount” in the pull-down menu MN shown in FIG. 5 is set as a comparison item in step S3 in FIG. 6 will be described in detail below. In the case where the exposure amount is set as a comparison item, the process in step S4 in FIG. 6 is not performed on an input image.

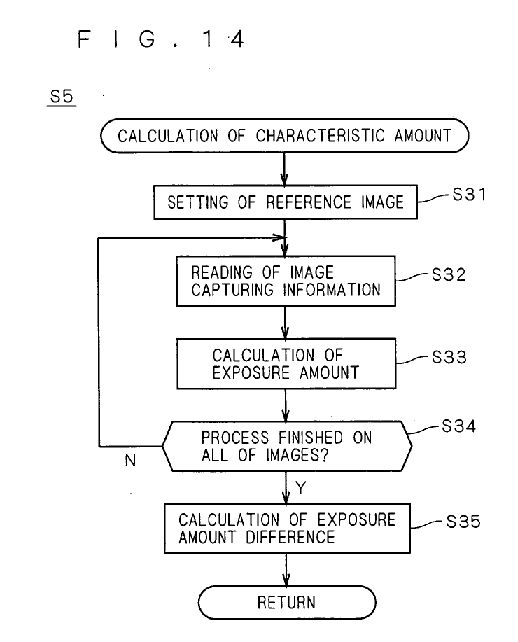

FIG. 14 is a flowchart corresponding to step S5 described above and showing a characteristic amount calculating operation.

In step S31, a reference image used as a reference at the time of comparing exposure amounts is set from the plurality of images input to the image input portion PG1. For example, from two images displayed on the first image area Da and the second image area Db shown in FIG. 4, an image selected with the mouse 211 is set as a reference image.

In step S32, image-capturing information indicative of settings at the time of image-capturing is read from Exif information and the like accompanying an input image.

In step S33, an exposure amount (characteristic amount) of each input image is calculated on the basis of the image-capturing information read in step S32. The calculating method will be concretely described.

First, information of shutter speed and aperture value related to an exposure value of an image is extracted from the image-capturing information added to the input image, and APEX values are calculated. The APEX values are obtained by converting elements related to exposure such as shutter speed, aperture value, and ISO sensitivity into logarithms. By setting the elements in the same system of units, comparison of exposure amounts is facilitated.

In the case where the shutter speed, aperture value, and ISO sensitivity converted to the APEX values are expressed as TV, AV, and SV, respectively, and the APEX value of a subject brightness is set as BV, the exposure amount EV can be expressed by Equation (5) as follows.
EV=AV+TV=BV+SV (5)

By substituting the APEX values TV and AV obtained from the shutter speed and the aperture value in the image-capturing information into Equation (5), the exposure amount EV can be calculated.

In step S34, whether the calculation of the exposure amount has been finished on all of images input to the image input portion PG1 or not is determined. For example, if input images are the two images A and B, whether computation on the two images has been finished or not is determined. In the case where the computation has finished on all of the images, the procedure advances to step S35. If not, the procedure returns to step S32.

In step S35, the exposure amount difference between the exposure amounts of the images calculated in step S33 is calculated. Concretely, when the exposure amount of the reference image set in step S31 is set as EV0 and the exposure amount of another input image “i” is set as EV(i), the exposure amount difference ΔEV(i) is computed by Equation (6) as follows.
ΔEV(i)=EV(i)−EV0 (6)

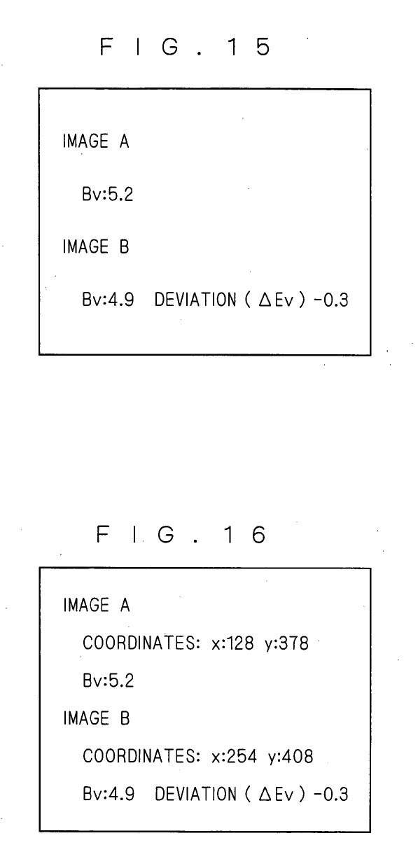

As described above, the difference of exposure amounts obtained as quantitative values by performing a predetermined process on various image-capturing data of a plurality of input images is expressed as, for example, the numerical value shown in FIG. 15 and displayed on the comparison result display area D3 (FIG. 4). Thus, the user can obtain a quantitative index with respect to exposure amount comparison between the images A and B.

With respect to the exposure amount, it is not essential to display comparison information of the exposure amounts of whole images as shown in FIG. 15. Alternatively, comparison information of the exposure amounts at points designated in a plurality of input images may be displayed. For example, as shown in FIG. 16, the exposure amount difference between the exposure amount in the point at the coordinates (128, 378) in the image A and the exposure amount in the point at the coordinates (254, 408) in the image B may be displayed. In this case, if a raw input image (“raw” image obtained by simply converting an output value from the image capturing device to a digital value) for the input image is used, the exposure amount of the designated point can be easily obtained.

(3) Comparison of White Balance

The operation in step S5 performed in the case where “white balance” in the pull-down menu MN shown in FIG. 5 is set as a comparison item in step S3 in FIG. 6 will be described in detail below. In the case where the white balance is set as the comparison item, the process in step S4 in FIG. 6 is not performed on an input image.

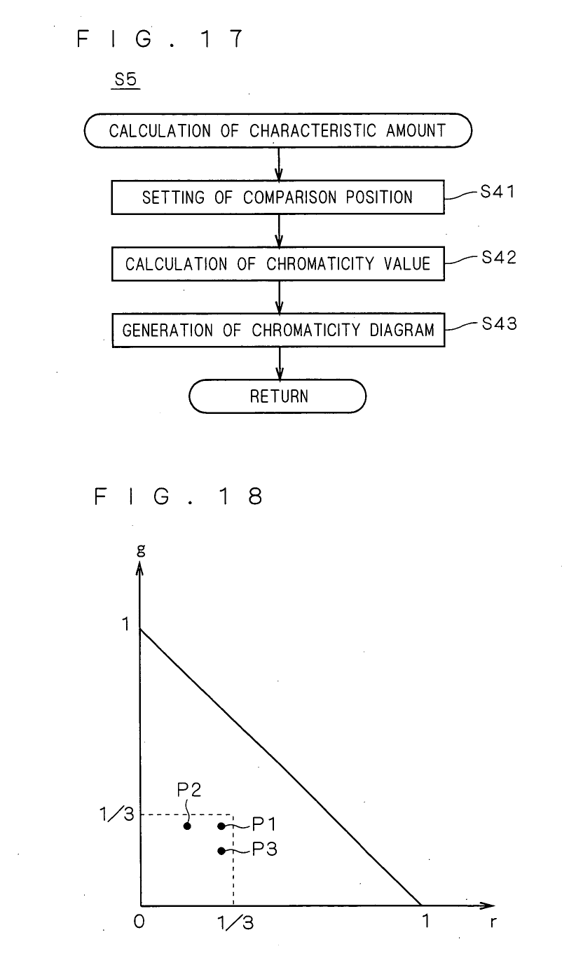

FIG. 17 is a flowchart corresponding to step S5 described above and showing the characteristic amount calculating operation.

In step S41, comparison positions (image portions) in which white balance is to be compared in a plurality of images input to the image input portion PG1 are set. For example, a comparison area is set in each of the images displayed on the first and second image areas Da and Db shown in FIG. 4 by dragging with the mouse 211.

In step S42, on the basis of the pixel value in each of the comparison positions set in step S41, the chromaticity value (the value indicative of only a color obtained by eliminating the information of brightness) is calculated. That is, information of the chromaticity value as a characteristic amount is generated on the basis of each of designated image parts.

For example, in the case where image data is expressed in three colors of R, G, and B, the R, G, and B colors can be converted to chromaticity values “r” and “g” by Equation (7) as follows.

$$\begin{matrix}r = R / ( R + G + B ) \\ g = G / ( R + G + B )\end{matrix} \} \qquad ( 7 )$$

In step S43, a chromaticity diagram is created on the basis of the chromaticity values calculated in step S42. For example, as shown in FIG. 18, a chromaticity diagram is created by plotting chromaticity values P1, P2, and P3 to a graph having the vertical axis “g” and the horizontal axis “r”.

The chromaticity diagram (FIG. 18) created by the above-described operation is displayed on the comparison result display area D3 shown in FIG. 4. The user can therefore obtain a quantitative index of the white balance in comparison positions in input images. Further, in the white balance comparison, pixel values of R, G, and B in which the color components and brightness components are included are not simply compared with each other but the chromaticity values obtained by Equation (7) are compared, so that the optimum index can be provided.

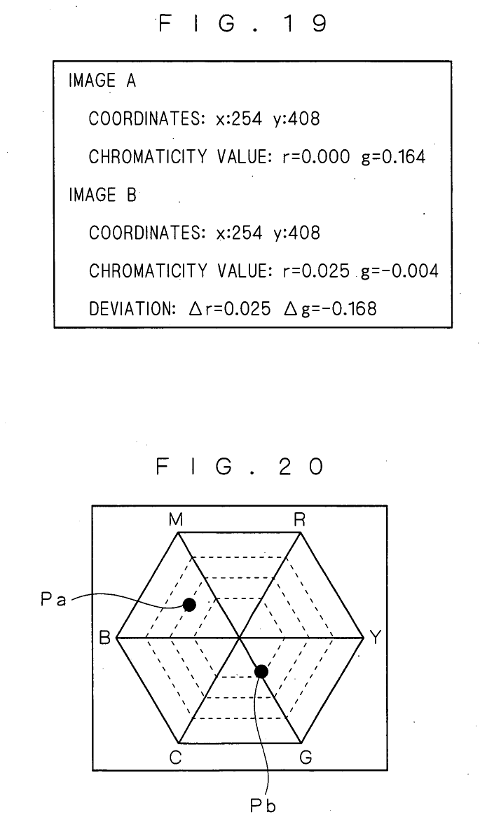

With respect to the white balance comparison, it is not essential to display a chromaticity diagram as shown in FIG. 18 but numerical values of chromaticity values shown in FIG. 19 may be displayed. The chromaticity values shown in FIG. 19 are calculated on the basis of Equation (8) where r=0 and g=0 in the case where white balance is kept, that is, in the case where R=G=B.

$$\begin{matrix}r = R / ( R + G + B ) - 1 / 3 \\ g = G / ( R + G + B ) - 1 / 3\end{matrix} \} \qquad ( 8 )$$

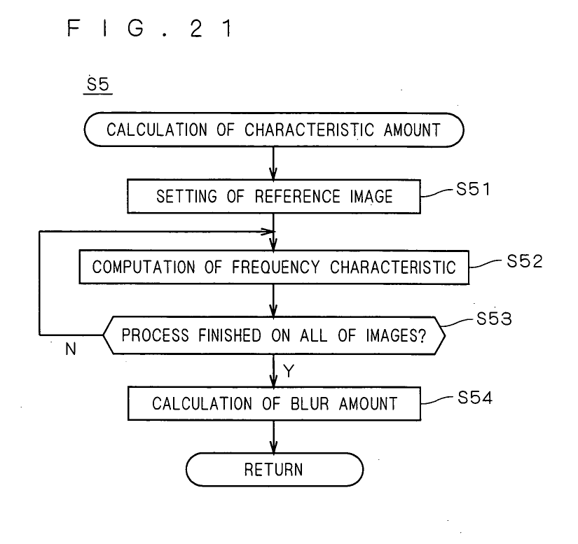

Alternatively, for example, the chromaticity values Pa and Pb are plotted to a graph as shown in FIG. 20 may be displayed. In this case as well, the chromaticity values are calculated on the basis of Equation (8) and the center of the graph of FIG. 20 becomes the point of r=g=0.

(4) Comparison of Blur Amounts

The operation in step S5 performed in the case where “blur amount” in the pull-down menu MN shown in FIG. 5 is set as a comparison item in step S3 in FIG. 6 will be described in detail below. In the case where the blur amount is set as a comparison item, the process in step S4 in FIG. 6 is not performed on an input image.

FIG. 21 is a flowchart corresponding to step S5 described above and showing the characteristic amount calculating operation.

In step S51, a reference image as a reference used at the time of comparing blur amounts is set from a plurality of images input to the image input portion PG1. For example, an image selected by the mouse 211 is set as a reference image from two images displayed on the first and second image areas Da and Db shown in FIG. 4.

In step S52, a frequency characteristic is computed on each of the plurality of images stored in the memory 242 in step S1 in FIG. 6. The computation of the frequency characteristic will be concretely described.

First, two-dimensional Fourier transform is performed on each of the input images to calculate Fourier spectrum F(H, V) and, after that, a power spectrum P(H, V) is calculated on the basis of Equation (9) as follows.
P(H,V)=|F(H,V)|² (9)

The power spectrum P(H, V) is calculated as the square of the absolute value of the Fourier spectrum F(H, V) and expresses an intensity distribution of each frequency. The relation between the power spectrum and the blur amount will now be described.

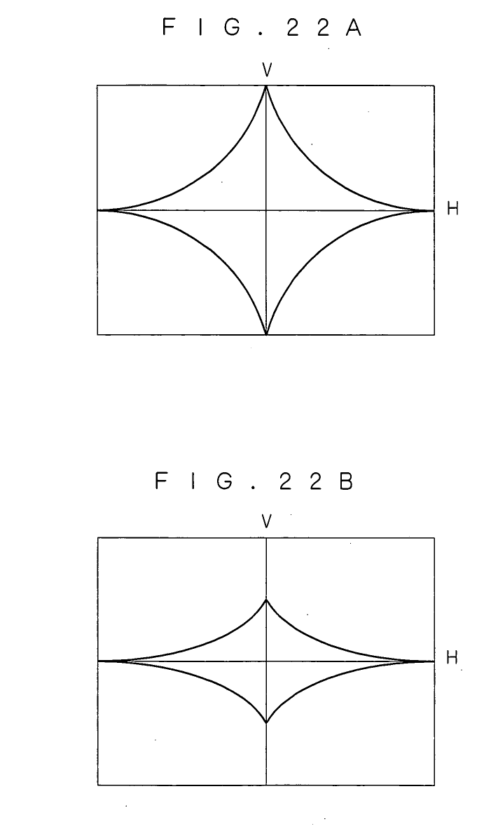

FIG. 22 is a diagram illustrating the relation between the power spectrum and the blur amount.

In an image where no blur occurs, various frequency components generally exist as vertical and horizontal components. Consequently, the intensity distribution of the power spectrum has spread (dispersion) from the low frequency to the high frequency in both vertical and horizontal directions V and H as shown in FIG. 22A.

On the other hand, in an image where blur occurs in the vertical direction, although there is no change in high frequency components in the horizontal direction H, the high frequency components in the vertical direction V decrease, so that spread (dispersion) in the vertical direction decreases as shown in FIG. 22B. Similarly, in an image where blur occurs in the horizontal direction, there is no change in high frequency components in the vertical direction V, but high frequency components in the horizontal direction H decrease. Thus, spread in the horizontal direction decreases.

As described above, the degree of spread of the power spectrum and the blur amount are closely related to each other.

In step S53, whether computation of the frequency characteristic has been finished on all of images input to the image input portion PG1 or not is determined. For example, if input images are two images A and B, computation on the two images has been finished or not is determined. In the case where computation on all of images has been finished, the procedure advances to step S54. If not, the procedure returns to step S52.

In step S54, the blur amount is calculated on the basis of the frequency characteristic (power spectrum) computed in step S52. The calculation of the blur amount will be concretely explained.

With respect to the blur amount, the one-dimensional integral value of the power spectrum P(H, V) is considered as an evaluation value expressing the blue amount of an input image.

For example, a one-dimensional integral value S(i) of the power spectrum P(H, V) in the vertical direction of an input image “i” is calculated on the basis of Equation (10) as follows.
S(i)=∫P(H,V)dV (10)

When the one-dimensional integral value of the power spectrum P(H, V) of the reference image set in step S51 in FIG. 21 is expressed as S(0), a relative blur amount Vib(i) of the input image “i” to the reference image can be calculated by Equation (11) as follows.
Vib(i)=S(i)/S(0) (1.1)

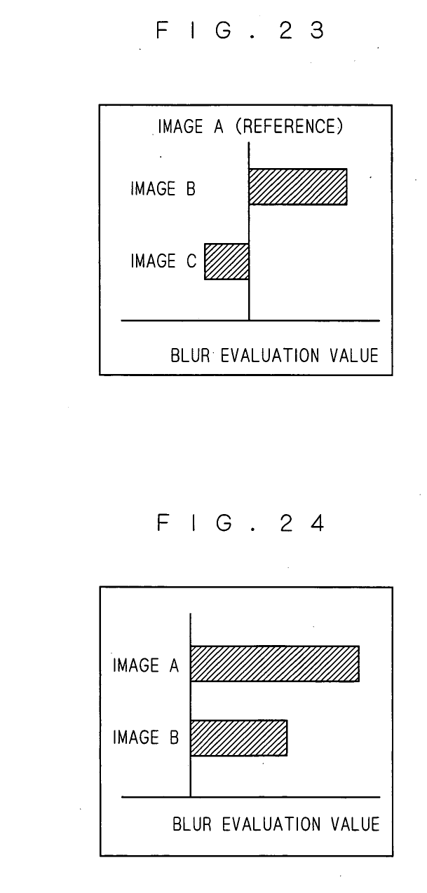

The relative blur amount Vib(i) calculated as a blur evaluation value by the above operation is expressed as a graph shown in FIG. 23 and is displayed on the comparison result display area D3 (FIG. 4). In such a manner, the user can obtain a quantitative index of blur amount comparison between the images A and B.

With respect to the blur evaluation value, it is not essential to perform display based on the relative value with respect to the reference image as shown in FIG. 23 but it is possible to perform display based on the absolute value S(i) calculated by Equation (10) on each of input images as shown in FIG. 24.

By the operation of the image processing apparatus 2, the characteristic amount of each input image is calculated with respect to a selected comparison item, and display based on the numerical information is performed. Thus, in the case of comparing a plurality of images, a quantitative index can be provided.

Modifications

With respect to the operation on an image in the foregoing preferred embodiment (step S7 in FIG. 6), it is not essential to perform operations interactively on images. It is also possible to allow only images requiring interaction to be selected and to operate only the images selected by the user interactively.

In the foregoing preferred embodiment, it is not essential to input an image from the digital camera 3 to the image processing apparatus 2 but it is also possible to input an image via the memory card 92 inserted into the drive 202 or via a network.

For setting of a reference image in the foregoing preferred embodiment, a toggle button, a check button, or the like for designating a reference image may be provided for each image displayed on the screen and a setting may be made by clicking the button.

It is not essential to individually set the comparison position in the foregoing preferred embodiment by dragging the mouse 211 in each image. Alternatively, by setting a comparison position in one image, the comparison position of the same coordinates may be set in other images interactively.

Although two images are compared with each other in the foregoing preferred embodiment, three or more images may be compared with each other.

While the invention has been shown and described in detail, the foregoing description is in all aspects illustrative and not restrictive. It is therefore understood that numerous modifications and variations can be devised without departing from the scope of the invention.

What is claimed is:

1. An image comparing method comprising the steps of:
(a) obtaining a plurality of images to be compared;
(b) generating numerical information of a specific comparison item on the basis of each of said plurality of images; and
(c) displaying said plurality of images in parallel on a display screen and performing information display based on said numerical information.

2. The image comparing method according to claim 1, wherein
said numerical information is information of a numerical value obtained as a quantitative value by performing a predetermined process on data of said plurality of images.

3. The image comparing method according to claim 1, wherein
said numerical information is information of a numerical value obtained as an evaluation value to be used for comparison evaluation from each of said plurality of images.

4. The image comparing method according to claim 1, wherein
said numerical information is information selected from a group consisting of information of a high frequency component, information of an exposure amount, information of a chromaticity value, and information of a blur amount.

5. The image comparing method according to claim 1, wherein
said information display includes display based on a relative value with respect to a reference value.

6. The image comparing method according to claim 5, wherein
said reference value is obtained on the basis of one image selected as a reference image from said plurality of images.

7. The image comparing method according to claim 1, wherein
said step (b) includes the step of:
(b-1) selecting said specific comparison item from a plurality of comparison items.

8. The image comparing method according to claim 1, wherein
said step (b) includes the steps of:
(b-2) designating an image portion to be compared in each of said plurality of images; and
(b-3) generating said numerical information on the basis of each of image portions designated in said step (b-2).

9. A computer program product for making a computer execute the steps of:
(a) obtaining a plurality of images to be compared;
(b) generating numerical information of a specific comparison item on the basis of each of said plurality of images; and
(c) displaying said plurality of images in parallel on a display screen and performing information display based on said numerical information.

10. The computer program product according to claim 9, wherein
said numerical information is information of a numerical value obtained as a quantitative value by performing a predetermined process on data of said plurality of images.

11. The computer program product according to claim 9, wherein
said numerical information is information of a numerical value obtained as an evaluation value to be used for comparison evaluation from each of said plurality of images.

12. The computer program product according to claim 9, wherein
said numerical information is information selected from a group consisting of information of a high frequency component, information of an exposure amount, information of a chromaticity value, and information of a blur amount.

13. The computer program product according to claim 9, wherein
said information display includes display based on a relative value with respect to a reference value.

14. The computer program product according to claim 13, wherein
said reference value is obtained on the basis of one image selected as a reference image from said plurality of images.

15. An image comparing apparatus having a display screen capable of displaying an image, comprising:
(a) an obtaining part for obtaining a plurality of images to be compared;
(b) a numerical information generator for generating numerical information of a specific comparison item on the basis of each of said plurality of images; and
(c) a display controller for displaying said plurality of images in parallel on said display screen and performing information display based on said numerical information.

16. The image comparing apparatus according to claim 15, wherein
said numerical information is information of a numerical value obtained as a quantitative value by performing a predetermined process on data of said plurality of images.

17. The image comparing apparatus according to claim 15, wherein
said numerical information is information of a numerical value obtained as an evaluation value to be used for comparison evaluation from each of said plurality of images.

18. The image comparing apparatus according to claim 15, wherein
said numerical information is information selected from a group consisting of information of a high frequency component, information of an exposure amount, information of a chromaticity value, and information of a blur amount.

19. The image comparing apparatus according to claim 15, wherein
said information display includes display based on a relative value with respect to a reference value.

20. The image comparing apparatus according to claim 19, wherein
said reference value is obtained on the basis of one image selected as a reference image from said plurality of images.
